(19) United States
(12) Patent Application Publication
(10) Pub. No.: US 2009/0136003 A1
(43) Pub. Date: May 28, 2009

(54) Protective envelope for a radiographic sensor

(76) Inventor: Gerald Gestetner, Montreal (CA)

Correspondence Address: Louis Tessier, P.O. Box 54029, Town of Mount-Royal, QC, H3P 3H4, CA

(21) Appl. No.: 12/292,493

(22) Filed: Nov. 20, 2008

Related U.S. Application Data
(60) Provisional application No. 60/996,542, filed on Nov. 23, 2007.

(51) Int. Cl. H01J 31/50

(52) U.S. Cl. 378/189

(57) ABSTRACT

A protective envelope for a radiographic sensor. The protective envelope includes: a first sheet of polymer defining a first sheet peripheral edge; a second sheet of polymer defining a second sheet peripheral edge, the second sheet of polymer extending substantially parallel to the first sheet of polymer with the first and second sheet peripheral edges substantially adjacent to each other; the first and second sheets of polymer being welded to each other along a weld band extending along a portion of the first and second sheet peripheral edges; the protective envelope defining an envelope first end edge, a substantially opposed envelope second end edge and two substantially opposed envelope side edges extending therebetween; the weld band extending along the envelope second end edge and along a respective portion of each of the envelope first and second side edges extending from the envelope second end edge; the weld band defining a corner section substantially adjacent a junction of the envelope second end edge with one of the envelope first and second side edges; the weld band defining a notch extending substantially obliquely into the corner section from the first and second sheet peripheral edges.

The present application claims priority from U.S. provisional patent application Ser. No. 60/996,542 filed on Nov. 23, 2007.

### FIELD OF THE INVENTION

The present invention relates to the general field of radiography, and is more specifically concerned with a protective envelope for a radiographic sensor.

### BACKGROUND

There has been a move in recent years towards digital radiography systems in many fields. For example, in dental radiography, it is increasingly common to replace the conventional radiographic film with a re-usable sensor. Since these sensors are typically heat-sensitive, there is a need to protect the sensor from contamination by bodily fluids when using the sensor to obtain a radiographic image. Indeed, it is typically not possible to autoclave or otherwise sterilize these sensors using extreme environmental conditions, and they therefore need to be protected from contamination.

To that effect, many protective envelopes usable for protecting these sensors have been developed. However, because of size limitations due to their use in the mouth of patients, these protective envelopes are subject to relatively severe design criteria. Because of these design criteria, most of the protective envelopes present in the prior art do not provide a reliable perfect seal and create a risk that saliva may come into contact with the radiographic sensor.

Yet, furthermore, after use of the envelope and exposition to X-ray radiation, there is a need to remove the radiographic sensor from the envelope. Once again, commonly used radiographic protective envelopes have proven unsatisfactory in this regard as they are typically relatively difficult to tear apart so that the radiographic sensor can be removed.

U.S. Pat. No. 6,866,149 issued Mar. 15, 2005 to Alzmer describes a protective envelope in which a slit has been formed to facilitate tearing apart of the envelope. However, this slit extends substantially parallel to the top and bottom edges of the envelope and it has been found that interference between the envelope and the radiographic sensor contained therein sometimes provides an envelope in which the radiographic sensor is relatively difficult to remove. Indeed, tearing apart the envelope is relatively difficult and, when this operation is satisfactory, access to the radiographic sensor is provided through a relatively small aperture that substantially tightly fits to the radiographic sensor. Because of the small dimensions of the envelope and sensor, this renders removal of the sensor from the envelope relatively difficult to perform as the sensor sticks to the interior of the envelope and the aperture formed in the envelope is too small to provide easy access to the fingers of an intended user.

Against this background, there exists a need in the industry to provide an improved protective envelope for a radiographic sensor. An object of the present invention is therefore to provide such a protective envelope for a radiographic sensor.

### SUMMARY OF THE INVENTION

In a broad aspect, the invention provides a protective envelope for a radiographic sensor. The protective envelope includes: a first sheet of polymer defining a first sheet peripheral edge; a second sheet of polymer defining a second sheet peripheral edge, the second sheet of polymer extending substantially parallel to the first sheet of polymer with the first and second sheet peripheral edges substantially adjacent to each other; the first and second sheets of polymer being welded to each other along a weld band extending along a portion of the first and second sheet peripheral edges; the protective envelope defining an envelope first end edge, a substantially opposed envelope second end edge and two substantially opposed envelope side edges extending therebetween; the weld band extending along the envelope second end edge and along a respective portion of each of the envelope first and second side edges extending from the envelope second end edge; the weld band defining a corner section substantially adjacent a junction of the envelope second end edge with one of the envelope first and second side edges; the weld band defining a notch extending substantially obliquely into the corner section from the first and second sheet peripheral edges.

Advantageously, it has been found that, unexpectedly, the substantially oblique, and in some embodiments of the invention diagonal, orientation of the notch greatly facilitates removal of the radiographic sensor from the protective envelope after use by facilitating tearing apart of the protective envelope along one of its diagonal. Indeed, such protective envelopes, especially when used in dental radiography applications, are relatively small. Therefore, tearing apart the envelope along a diagonal facilitates handling of the radiographic sensor by the hand and fingers of an intended user and, therefore, minimizes risks of damaging the radiographic sensor during handling, minimizes risks that the image detected by the radiographic sensor could be damaged during this handling, and reduces the time required to handle the protective envelope and the radiographic sensor to get access to the image detected by the radiographic sensor. All these advantages contribute to a greater efficiency in a dental office in which, typically, a patient that has been subjected to a dental radiography usually waits for the results of the radiography for the dental practitioner to suggest a treatment, if required.

In some embodiments of the invention, the envelope first and second side edges each define a welded portion in a region in which the weld band is provided and an unwelded portion. Typically, the unwelded portion extends from the envelope first end edge to a location located between the envelope first and second end edges. The welded portion extends from this location up to the envelope second end edge and along the envelope second end edge.

In some embodiments, a band of glue extends along the envelope first end edge and has a width such that the unwelded portion is substantially in register with the band of glue. This configuration of the band of glue facilitates filling of the protective envelope and greatly reduces the risks that bodily fluids such as, for example, saliva and, in cases in which the patient is injured, blood, enter the protective envelope and contaminate the radiographic sensor. Indeed, since the glue extends along all the portions of the protective envelope that are not welded, a good seal will be formed in the protective envelope when the protective envelope is sealed for use in the mouth of the patient.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawing:

FIG. 1A, in a perspective view, illustrates a protective envelope in accordance with an embodiment of the invention;

FIG. 1B, in a perspective exploded view, illustrates the protective envelope shown in FIG. 1A containing a radiographic sensor;

FIG. 2A, in a top cross-sectional view taken along the line 2A-2A of FIG. 1A, illustrates the protective envelope shown in FIGS. 1A and 1B;

FIG. 2B, in a side cross-sectional view taken along the line 2B-2B of FIG. 1A, illustrates the protective envelope shown in FIGS. 1A to 2A;

FIG. 3, in a side cross-sectional view, illustrates a protective envelope in accordance with an alternative embodiment of the present invention; and

FIG. 4, in a side cross-sectional view, illustrates a protective envelope in accordance with another alternative embodiment of the present invention.

### DETAILED DESCRIPTION

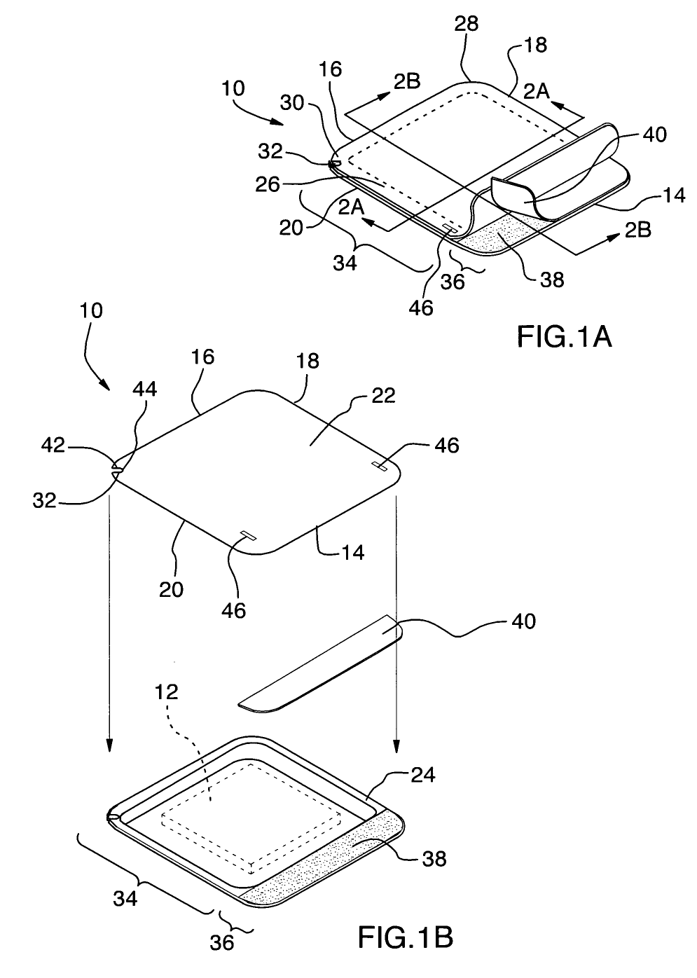

Referring to FIG. 1A, there is shown a protective envelope 10. In FIG. 1A, the protective envelope is shown empty. As seen in FIG. 1B, the protective envelope 10 is usable to protect a radiographic sensor 12. For example, the radiographic sensor 12 is a phosphor plate usable for performing radiography in a conventional manner.

Referring to FIG. 1A, the protective envelope 10 defines an envelope first end edge 14, a substantially opposed envelope second end edge 16 and two substantially opposed envelope side edges 18 and 20 extending therebetween. For example, the protective envelope 10 has a generally square or rectangular shape and, in these embodiments, the envelope first and second end edges 14 and 16 are substantially parallel to each other and the envelope side edges 18 and 20 are also substantially parallel to each other and extend generally perpendicularly relatively to the envelope first and second end edges 14 and 16.

As better seen in FIG. 1B, the protective envelope 10 includes a first sheet of polymer 22 and a second sheet of polymer 24 extending substantially parallel to the first sheet of polymer 22. Typically, the first sheet of polymer is substantially transparent while the second sheet of polymer 24 is substantially opaque. However, in alternative embodiments of the invention, the first and second sheets of polymer 22 and 24 are any other suitable sheets of polymer: For example, the first and second sheets of polymer 22 and 24 are made out of Polyvinyl chloride (PVC).

The first and second sheets of polymer 22 and 24 are welded to each other along a weld band 26, better seen in FIG. 1A. For example, the first and second sheets of polymer 22 and 24 are welded using the radiofrequency (RF) welding technology. As described in further details hereinbelow, this method of welding allows for manufacturing a protective envelope having specific structures that have proven to be advantageous for many applications. However, in alternative embodiments of the invention, the weld band 26 is any other suitable weld band 26 and may include, for example, a weld band 26 formed by ultrasonic welding, among other possibilities. Yet, in other embodiments of the invention, the first and second sheets of polymer 22 and 24 are attached to each other in any other suitable manner.

The first and second sheets of polymer 22 and 24 each define a respective peripheral edge. Typically, the peripheral edges of the first and second sheets of polymer 22 and 24 are substantially adjacent to each other and coincident by the closed curved defined by the envelope first and second end edges 14 and 16 and the envelope side edges 18 and 20.

The weld band 26 extends along the envelope second end edge 16 and along a portion of each of the envelope side edges 18 and 20. Typically, the weld band 26 is substantially uninterrupted along its entire length.

The weld band 26 defines corner sections 28 and 30 respectively substantially adjacent the junction of the envelope second end edge 16 and each of the envelope side edges 18 and 20. The weld band 26 also defines a notch 32 extending substantially obliquely into one of the corner sections 28 and 30, for example the corner section 30, from the junction of the envelope second end edge 16 and one of the envelope side edges 18 and 20, for example from the envelope side edge 20. In other words, the notch 32 is not parallel to any of the envelope first end, second end and side edges 14, 16, 18 and 20. In some embodiments of the invention, the notch 32 extends substantially diagonally into one of the corner sections 28 and 30.

The envelope side edges 18 and 20 each define a welded portion 34 and an unwelded portion 36 extending therefrom. In the welded portion 34, the first and second sheets of polymer 22 and 24 are welded to each other. In the unwelded portion 36, the first and second sheets of polymer are not welded to each. For example, the welded portion 34 extends from the envelope second end edge 16 towards the envelope first end edge 14. The welded portion 34 ends at a location spaced apart from the envelope first end edge 14, this location being a location at which the unwelded portion 36 begins and extends up to the envelope first end edge 14.

A band of glue 38 extends along the envelope first end edge 14. Typically, the band of glue 38 extends between the two envelope side edges 18 and 20 along the entire length of the envelope first end edge 14 and has a width such that substantially adjacent the envelope side edges 18 and 20, the band of glue 38 extends along the entire unwelded portion 36. The band of glue 38 is applied to one of the first and second sheets of polymer 22 and 24 and located between the first and second sheets of polymer 22 and 24, typically to the second sheet of polymer 24.

When manufactured, and before being used to seal the radiographic sensor 12, the protective envelope 10 includes a protective strip 40 that covers the band of glue 38. Typically, the protective strip 40 has dimensions substantially similar to the dimensions of the band of glue 38 and is glued thereto substantially in register therewith. Typically, the protective strip 40 is made out of a material that adheres to the band of glue 38, but nevertheless makes removal of the protective strip 40 from the band of glue 38 relatively easy to perform. Many such couples of strip material and glue are well known in the art and these materials will therefore not be described in further details herein.

Referring to FIG. 1B, the notch 32 defines a notch first section 42 and a notch second section 44. The notch first section 42 extends from the junction of the envelope second end edge 16 and the envelope side edge 20 into the weld band 26 substantially diagonally relatively to the envelope second end edge 16 and the envelope side edge 20. The notch second section 44 extends substantially longitudinally from the notch first section 42 and is entirely located within the weld band 26. In other words, the notch 32 is not large enough to provide access to the interior of the protective envelope 10 without damaging the protective envelope 10.

Typically, the notch first section 42 is substantially rectilinear and the notch second section 44 is substantially concave. This concave configuration of the notch second section 44 which is, for example, hemi-circular, creates stress concentrations that facilitate tearing apart of the protective envelope 10 by pulling on opposite sides of the notch 32 when it is desired to remove the radiographic sensor 12 from the protective envelope 10.

In some embodiments of the invention, the weld band 26 includes embossed portions 46 each located in the weld band 26 substantially adjacent the unwelded portion 36 substantially spaced apart from the envelope side edges 18 and 20. The embossed portions 46 have, for example, a substantially rectangular configuration and help in reducing risks that the junction between the first and second sheets of polymer 22 and 24 be torn apart unintentionally when an intended user uses the protective envelope 10.

In some embodiments of the invention, the first and second sheets of polymer 22 and 24 are made out of a material that heats up and at least partially melt when exposed to radiofrequency radiations. This facilitates manufacturing of the protective envelope 10 using RF welding. However, the protective strip 40 is typically made out of a material that is not heated up significantly by radiofrequency radiations, such as, for example, polyester. This allows for an easy manufacturing of the protective envelope 10 as the band of glue 38 may be applied to the second sheet of polymer 24 prior to welding the first and second sheets of polymer 22 and 24.

Afterwards, the protective strip 40 is applied and the first and second sheets of polymer 22 and 24 are positioned so as to be substantially in register with each other. Afterwards, radiofrequency radiation is applied along the welded portion 34 and along the envelope second end edge 16 to weld the first and second sheets of polymer 22 and 24 to each other to form the weld band 26. Since the protective strip 40 is not heated up during the RF application process, this method of manufacturing provides a clean, precise, and reproducible separation between the welded and unwelded portions 34 and 36, which helps in ensuring that the band of glue 38 extends so as to be almost in contact, or completely in contact, with the welded portion 34, which helps in ensuring that the protective envelope 10 is sealed properly in use, as described in further details hereinbelow.

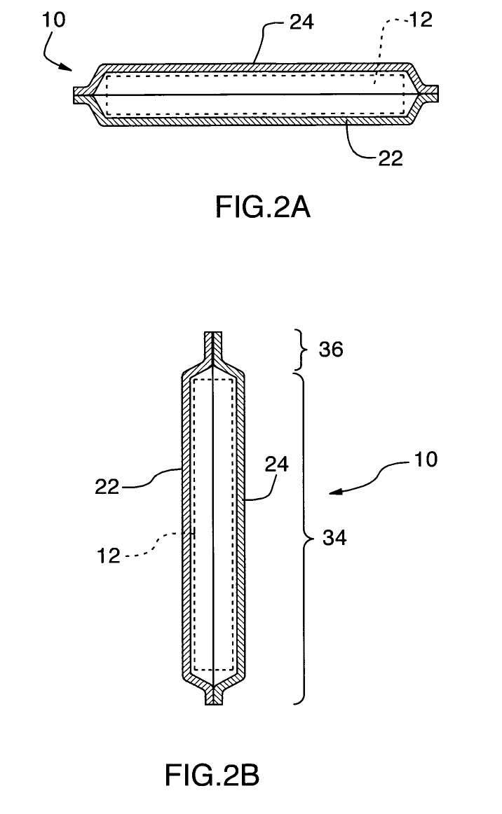

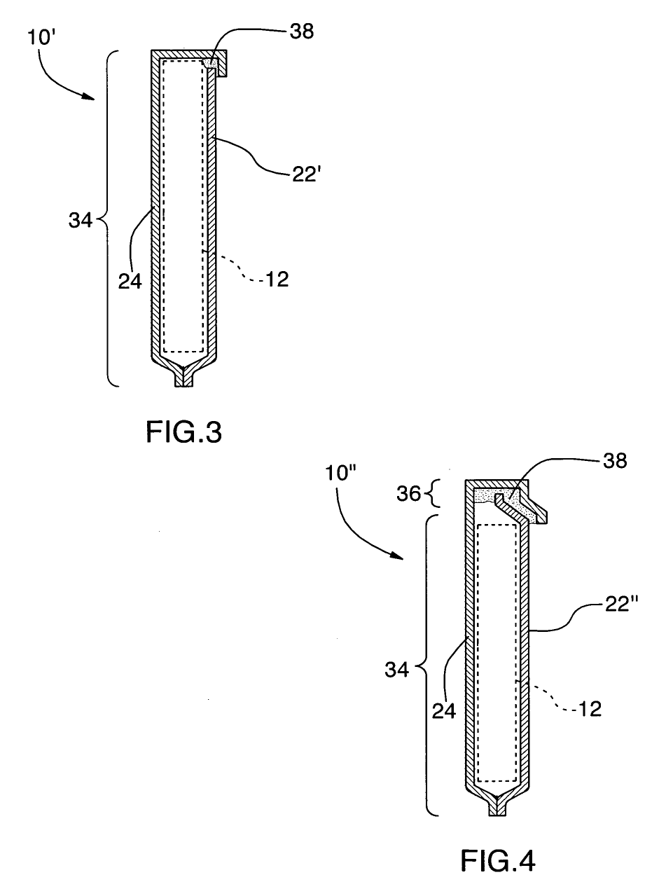

In the protective envelope 10 seen in FIG. 1, the first and second sheets of polymer 22 and 24 are of substantially similar dimensions. However, in other embodiments of the invention, the first sheet of polymer 22 is smaller than the second sheet of polymer 24, which provides different configurations of the protective envelope 10 and, therefore, provides different manners of closing the protective envelope 10. For example, as seen in the protective envelope 10′ of FIG. 3, if the first sheet of polymer 22′ is dimensioned such that the first sheet of polymer 22′ extends only along the welded portion 34, closing of the protective envelope 10′ occurs by folding the entire portion of the second sheet of polymer 24 that is covered with the band of glue 38 over the first sheet of polymer 22′. In cases in which the first and second sheets of polymer 22 and 24 are substantially identical in shape and dimensions, closing of the envelope occurs by simply pressing the first and second sheets of polymer towards each other after having removed the protective strip 40, as seen in FIG. 2B.

Finally, in an intermediate configuration in which the first sheet of polymer 22″ extends along only a portion of the band of glue 38, as seen in the protective envelope 10″ of FIG. 4, closing occurs by first sealing the first and second sheets of polymer 22″ and 24 to each other after having removed the protective strip 40 by pressing the first and second sheets of polymer 22″ and 24 to each other and, afterwards, folding the remaining portion of the band of glue 38 and the associated portion of the second sheet of polymer 24 over the first sheet of polymer 22″ to close the protective envelope 10.

Although the present invention has been described hereinabove by way of preferred embodiments thereof, it can be modified, without departing from the spirit and nature of the subject invention as defined in the appended claims.

What is claimed is:

1. A protective envelope for a radiographic sensor, said protective envelope comprising:
a first sheet of polymer defining a first sheet peripheral edge;
a second sheet of polymer defining a second sheet peripheral edge, said second sheet of polymer extending substantially parallel to said first sheet of polymer with said first and second sheet peripheral edges substantially adjacent to each other;
said first and second sheets of polymer being welded to each other along a weld band extending along a portion of said first and second sheet peripheral edges;
said protective envelope defining an envelope first end edge, a substantially opposed envelope second end edge and two substantially opposed envelope side edges extending therebetween;
said weld band extending along said envelope second end edge and along a respective portion of each of said envelope first and second side edges extending from said envelope second end edge;
said weld band defining a corner section substantially adjacent a junction of said envelope second end edge with one of said envelope first and second side edges;
said weld band defining a notch extending substantially obliquely into said corner section from said first and second sheet peripheral edges.
